(19) United States
(12) Patent Application Publication
(10) Pub. No.: US 2018/0287726 A1
(43) Pub. Date: Oct. 4, 2018

(54) TRANSMISSION DEVICE AND TRANSMISSION METHOD

(71) Applicant: FUJITSU LIMITED, Kawasaki-shi (JP)

(72) Inventor: Eiji Ishikawa, Kawasaki-shi (JP)

(73) Assignee: FUJITSU LIMITED, Kawasaki-shi (JP)

(21) Appl. No.: 15/914,581

(22) Filed: Mar. 7, 2018

(30) Foreign Application Priority Data
Mar. 28, 2017 (JP) 2017-063778

(51) Int. Cl. H04J 3/16; H04J 14/02; H04Q 11/00; H04L 12/935

(52) U.S. Cl. CPC H04J 3/1664; H04J 14/0223; H04J 14/0267; H04J 2203/003; H04J 14/0273; H04L 49/30; H04Q 11/0062

(57) ABSTRACT

A transmission device includes a processor configured to: extract data other than an idle signal from an input signal, generate a first frame in which the extracted data is stored, and store the generated first frames in a second frame, each of the generated first frames being the first frame; and a transmitter coupled to the processor and configured to: divide the second frame to transmit through a plurality of lines corresponding to storage areas of the first frames in the second frame among the plurality of lines, and when a failure occurs in a line among the plurality of lines, store the first frame corresponding to the line in which the failure occurs in an area, the first frame in the area being to be transmitted through a line different from the line in which the failure occurs.

### CROSS-REFERENCE TO RELATED APPLICATION

This application is based upon and claims the benefit of priority of the prior Japanese Patent Application No. 2017-63778, filed on Mar. 28, 2017, the entire contents of which are incorporated herein by reference.

### FIELD

The embodiments discussed herein are a transmission device and a transmission method.

### BACKGROUND

In a related art, a communication system using optical transmission such as an optical transport network (OTN) is known. A technology is known, in a configuration in which time-division multiplexing of signals input from two or more subscribers is performed and the signals are transmitted through two or more lines, a free channel of a normal line is detected, and a signal to be transmitted through an abnormal line is inserted into the free channel of the normal line (for example, see Japanese Laid-open Patent Publication No. 59-171331). A technology is known in which a bandwidth used for isochronous variable rate data transmission is monitored by another transmission device, and non-isochronous data is transmitted by using a free band (for example, see Japanese Laid-open Patent Publication No. 2000-49830).

However, in the above-described related arts, for example, in a configuration in which bonding of optical signals transmitted through the two or more lines is performed, it may be difficult to suppress impact on the communication service when a failure occurs in one or more of the lines. It is desirable that impact on the communication service is suppressed even when a failure occurs in one or more of the lines.

### SUMMARY

According to an aspect of the invention, a transmission device includes a processor configured to: extract data other than an idle signal from an input signal, generate a first frame in which the extracted data is stored, and store the generated first frames in a second frame, each of the generated first frames being the first frame; and a transmitter coupled to the processor and configured to: divide the second frame to transmit through a plurality of lines corresponding to storage areas of the first frames in the second frame among the plurality of lines, and when a failure occurs in a line among the plurality of lines, store the first frame corresponding to the line in which the failure occurs in an area, the first frame in the area being to be transmitted through a line different from the line in which the failure occurs.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a transmission system according to an embodiment;

FIG. 2 is a diagram illustrating an example of a first transmission device according to the embodiment;

FIG. 3 is a diagram illustrating an example of a second transmission device according to the embodiment;

FIG. 4 is a diagram illustrating an example of an OTUCn frame transmitted in the transmission system according to the embodiment;

FIG. 5 is a diagram illustrating an example of an MSI included in the OTUCn frame transmitted in the transmission system according to the embodiment;

FIG. 6 is a flowchart illustrating an example of processing by the first transmission device according to the embodiment;

FIG. 7 is a flowchart illustrating an example of processing by the second transmission device according to the embodiment;

FIG. 8 is a diagram illustrating an example of transmission of the OTUCn frame in the transmission system according to the embodiment;

FIG. 9 is a diagram illustrating an example of failure of some physical lines and diversion away from the physical lines in the transmission system according to the embodiment;

FIG. 10 is a diagram illustrating an example of allocation of data to relief lines in the transmission system according to the embodiment;

FIG. 11 is a diagram illustrating an example of an ODU flex frame according to the embodiment;

FIG. 12 is a diagram illustrating an example of an ODTUCn frame and OPUCn/ODUCn/OTUCn frames according to the embodiment; and

FIG. 13 is a diagram illustrating an example of a hardware configuration of each of the transmission devices according to the embodiment.

### DESCRIPTION OF EMBODIMENTS

Embodiments of a transmission device and a transmission method of the technology discussed herein are described below in detail with reference to drawings.

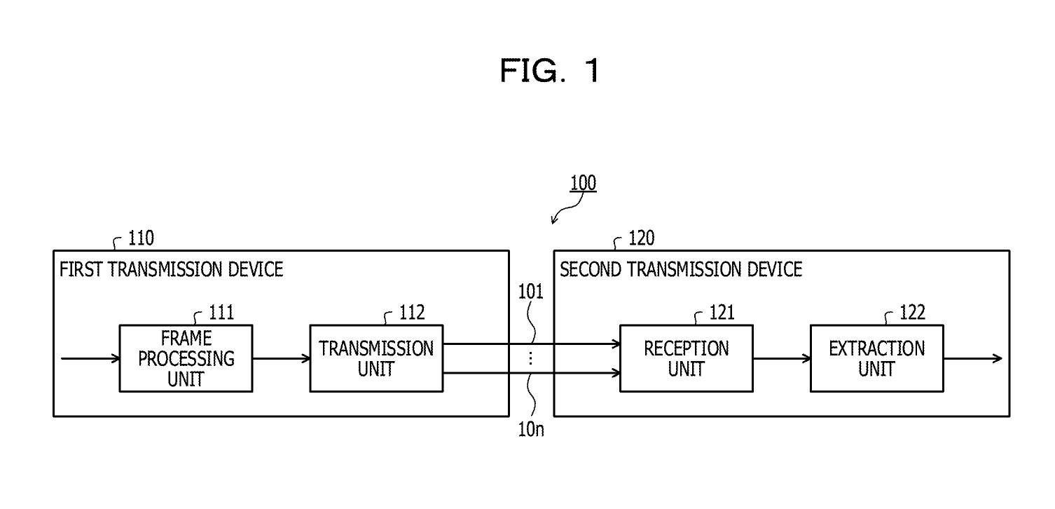

FIG. 1 is a diagram illustrating a transmission system according to an embodiment. As illustrated in FIG. 1, a transmission system 100 according to the embodiment includes a first transmission device 110 and a second transmission device 120. The first transmission device 110 and the second transmission device 120 are coupled to each other through two or more lines 101 to 10n. Here, “n” is a natural number of 2 or more.

The lines 101 to 10n are, for example, physical lines through each of which an optical signal is transmitted. The lines 101 to 10n may be, for example, optical transmission paths such as two or more optical fibers or two or more wavelength channels realized by an optical transmission path such as a single optical fiber.

In the example illustrated in FIG. 1, a case is described below in which pieces of data are transmitted from the first transmission device 110 to the second transmission device 120 through the lines 101 to 10n. The first transmission device 110 includes a frame processing unit 111 and a transmission unit 112.

A signal including valid data and an idle signal is input to the frame processing unit 111. Examples of the signal input to the frame processing unit 111 include Ethernet (registered trademark) data that is described later. In this case, the valid data is, for example, a media access control (MAC) frame. Logically speaking, the idle signal is, for example, a no-signal section. The frame processing unit 111 extracts the data (valid data) other than the idle signal from the input signal.

As a result, data that has been obtained by compressing the band of the signal input to the frame processing unit 111 may be obtained. The frame processing unit 111 generates a first frame in which the extracted data is stored. Examples of the first frame include an ODU flex frame that is described later. The ODU is an abbreviation of optical-channel data unit.

The frame processing unit 111 stores the generated first frames in a second frame. For example, the frame processing unit 111 stores two or more first frames in respective areas of the payloads of the second frame. Examples of the second frame include an optical-channel transport unit 100G×n (OTUCn) frame that is described below. Examples of the area of the payload of the second frame include a tributary slot (TS) that is described below. In addition, the frame processing unit 111 outputs to the transmission unit 112 the second frame in which the generated first frames are stored.

The transmission unit 112 divides and transmits the second frame that has been output from the frame processing unit 111 to the second transmission device 120 through the lines 101 to 10n corresponding to the storage areas of the first frames in the second frames. When the second frame is an OTUCn frame as an example, the transmission unit 112 transmits the generated second frame (OTUCn frame) as two or more OTUCn sub-frames through the lines 101 to 10n.

When a failure occurs in one or more of the lines 101 to 10n, the transmission unit 112 transmits first frames corresponding to the lines in each of which the failure has occurred (failure line) from among the first frames generated by the frame processing unit 111, through other lines (relief lines). The failure of a line includes, for example, a failure in which an optical signal is not allowed to be transmitted through the line and a failure in which a transmission speed of an optical signal through the line is reduced. The first frame corresponding to the failure line is, for example, a first frame that has been allocated to an area, the first frame in which is to be transmitted through the failure line from among the areas of the second frame before the failure occurs.

For example, the transmission unit 112 stores the first frame corresponding to the failure line in an area to be transmitted through a relief line different from the failure line from among the areas of the second frame. As a result, the first frame corresponding to the failure line is transmitted through the relief line.

The band of the first frame is compressed by the frame processing unit 111, such that the free space of the relief line becomes large, and the band of the first frame corresponding to the failure line becomes small. Therefore, diversion away from the failure line may be performed while a reduction in the communication speed of the relief line due to insertion of the first frame corresponding to the failure line into the relief line is suppressed. Therefore, impact on the communication service when a failure has occurred in one or more of the lines 101 to 10n may be suppressed.

The second transmission device 120 includes a reception unit 121 and an extraction unit 122. The reception unit 121 receives the second frame that has been transmitted as the OTUCn sub-frames through the lines 101 to 10n from the first transmission device 110. In addition, the reception unit 121 outputs the received second frame to the extraction unit 122. The extraction unit 122 extracts the first frames from the second frame that has been output from the reception unit 121 and extracts the original data from the extracted first frame. The extraction unit 122 may insert an idle signal into the extracted original data and output the data.

As described above, in the configuration in which a second frame that stores two or more first frames is divided and transmitted through two or more lines, data other than an idle signal is extracted from an input signal, and the extracted data is stored in a first frame, such that the first frame the band of which has been compressed may be obtained. In addition, when a failure has occurred in one or more of the lines, a first frame corresponding to the line in which the failure has occurred may be stored in an area of the second frame, which is to be transmitted through another line. As a result, impact on the communication service may be suppressed even when a failure occurs in one or more of the lines.

The first frame may be, for example, a frame obtained first framing operation (ODU flex frame as an example) among framing operations performed before the data that has been extracted from the input signal is stored in the second frame. As a result, switching of a line may be performed in a unit of a first frame the data size of which is small. Therefore, diversion away from a failure line is performed in a short time period, and an impact on the communication service may be suppressed.

The first transmission device 110 includes two or more input ports, and signals may be input through the respective two or more input ports to the frame processing unit 111. In this case, the frame processing unit 111 generates the above-described first frame in accordance with the input signal from each of the two or more input ports. For example, the two or more input ports include a first input port and a second input port. In this case, the frame processing unit 111 extracts valid data from the signal that has been input from the first input port and generates a first frame in which the extracted data is stored. The frame processing unit 111 extracts valid data from the signal that has been input from the second input port. In addition, the frame processing unit 111 generates a first frame in which the extracted data is stored.

In this case, the frame processing unit 111 stores the first frame in a second frame such that the first frame is transmitted through a line corresponding to the input port of the data of the generated first frame. For example, the frame processing unit 111 stores a first frame that has been generated in accordance with the signal that had been input from the first input port in an area to be transmitted through the first line from among areas of the second frame. The frame processing unit 111 stores a first frame that has been generated in accordance with the signal that had been input from the second input port in an area to be transmitted through the second line from among the areas of the second frame. The second line is a line different from the first line from among the lines 101 to 10n.

In this case, the frame processing unit 111 includes, in the generated second frame, correspondence information between the areas of the second frame, in each of which the first frame is stored, and output ports corresponding to the respective two or more input ports. The output ports corresponding to the respective two or more input ports are, for example, two or more output ports of the second transmission device 120 corresponding to the respective two or more input ports of the first transmission device 110.

The correspondence information is, for example, information indicating an output port through which the first frame stored in each of the areas of the second frame is to be output. Examples of the correspondence information include an MSI in which TSs and TPs are associated with each other, which is described below. The TP is an abbreviation of tributary port. For example, the TP is a physical port number on the client side. The MSI is an abbreviation of multiplex structure identifier.

The extraction unit 122 of the second transmission device 120 outputs data of the first frame that has been extracted from each of the areas of the second frame through an output port corresponding to the data from among the two or more output ports in accordance with the correspondence information included in the second frame that has been output from the reception unit 121. As a result, the first transmission device 110 divides and transmits the second frame that stores pieces of data that have input from the two or more ports, through the lines 101 to 10n, and the second transmission device 120 may output data of each of the first frames that have been extracted from the second frame through an appropriate output port.

In this case, when a failure has occurred in one or more of the lines, the transmission unit 112 of the first transmission device 110 may add, to the first frame corresponding to the failure line, destination port information indicating an output port corresponding to an input port of data of the first frame from among the two or more output ports. In addition, the transmission unit 112 stores the first frame to which the destination port information has been added in an area, the second frame in which is transmitted through a relief line.

In this case, when destination port information is added to the first frame that has been extracted from each of the areas of the second frame that had been output from the reception unit 121, the extraction unit 122 of the second transmission device 120 outputs the first frame through an output port indicated by the destination port information. As a result, a first frame corresponding to a failure line is transmitted through a relief line when a failure occurs in one or more of the lines, and the first frame corresponding to the failure line may be output from an appropriate output port even when a port corresponding to the relief line is different from a port corresponding to the failure line.

The frame processing unit 111 of the first transmission device 110 may obtain information indicating a line usage rate of an input signal from each of the two or more input ports. In addition, when a failure has occurred in one or more of the lines, the frame processing unit 111 may store a first frame corresponding to the failure line in an area of the second frame, which is transmitted through a relief line, in accordance with the obtained information. For example, the frame processing unit 111 selects an area in which the first frame corresponding to the failure line is to be stored, from among the areas of the second frame, in accordance with the information indicating the line usage rate. As a result, the first frame corresponding to the failure line may be transmitted through a relief line corresponding to the area that has been selected in accordance with the line usage rate, and impact on the communication service may be suppressed efficiently.

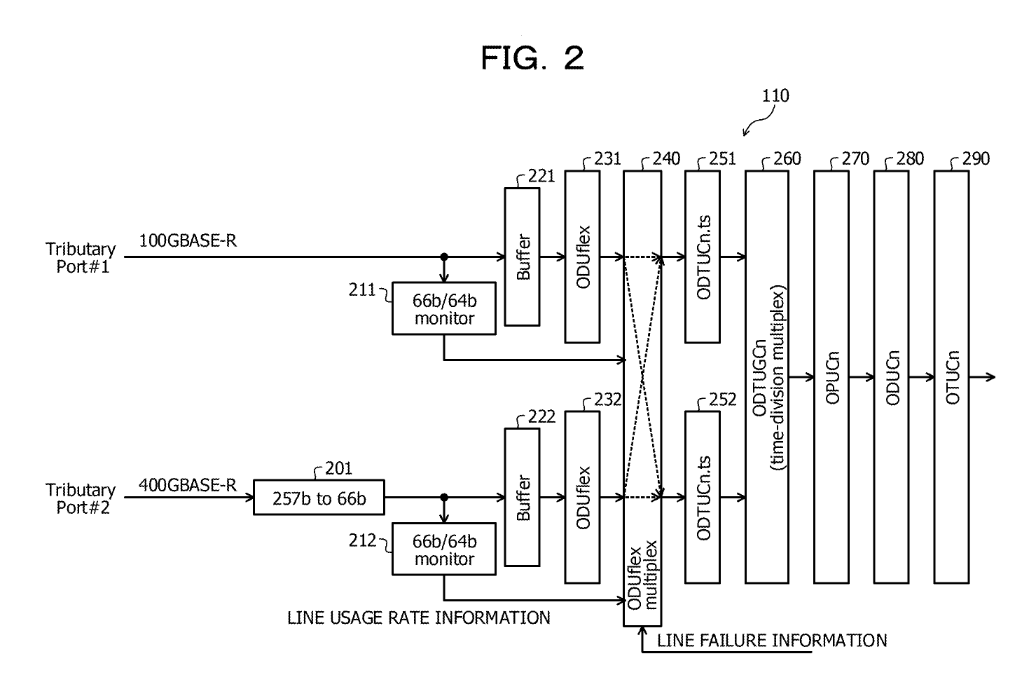

FIG. 2 is a diagram illustrating an example of the first transmission device according to the embodiment. A first transmission device 110 on the transmission side illustrated in FIG. 1 may be realized, for example, by a first transmission device 110 illustrated in FIG. 2. The first transmission device 110 illustrated in FIG. 2 includes, for example, a conversion unit 201 (257b to 66b), monitors 211 and 212 (66b/64b monitor), and buffers 221 and 222 (Buffer).

The first transmission device 110 includes ODU flex framers 231 and 232 (ODU flex), a multiplexer 240 (ODU flex multiplex), and ODTUCn framers 251 and 252 (ODTUCn.ts). The first transmission device 110 includes an ODTUGCn framer 260 (ODTUGCn), an OPUCn framer 270 (OPUCn), an ODUCn framer 280 (ODUCn), and an OTUCn framer 290 (OTUCn).

The ODTUCn is an abbreviation of optical-channel data tributary unit 100G×n. The ODTUGCn is an abbreviation of optical-channel data tributary unit group 100G×n. The OPUCn is an abbreviation of optical-channel payload unit 100G×n. The ODUCn is an abbreviation of optical-channel data unit 100G×n.

The frame processing unit 111 illustrated in FIG. 1 may be realized, for example, by the conversion unit 201, the buffers 221 and 222, and the ODU flex framers 231 and 232. The transmission unit 112 illustrated in FIG. 1 may be realized, for example, by the multiplexer 240, the ODTUCn framers 251 and 252, the ODTUGCn framer 260, the OPUCn framer 270, the ODUCn framer 280, and the OTUCn framer 290.

In the example illustrated in FIG. 2, the first transmission device 110 includes two ports (tributary ports #1 and #2). In addition, Ethernet data of 100GBASE-R specification is input to the tributary port #1. Ethernet data of 400GBASE-R specification is input to the tributary port #2. For example, 64b/66b coding in which 64-bit data is represented by a 66-bit symbol is performed on the Ethernet data of the 100GBASE-R specification. For example, 64b/66b coding in which 64-bit data is represented by a 66-bit symbol is performed on the Ethernet data of the 400GBASE-R specification, and then 66b/257b coding in which 66-bit data is represented by a 257-bit symbol is further performed on the Ethernet data of the 400GBASE-R specification.

The conversion unit 201 decodes the Ethernet data (257-bit) of the 400GBASE-R specification, which has been input from the tributary port #2, and converts the Ethernet data into 66-bit data. In addition, the conversion unit 201 outputs the Ethernet data that has been converted into the 66-bit data to the monitor 212 and the buffer 222.

The monitor 211 decodes the Ethernet data of the 100GBASE-R specification, which has been input from the tributary port #1, and converts the Ethernet data into 64-bit data. In addition, the monitor 211 continuously monitors a line usage rate of the Ethernet data that has been converted into the 64-bit data. In addition, the monitor 211 outputs line usage rate information indicating the monitored line usage rate to the multiplexer 240.

The monitor 212 decodes the Ethernet data that has been output from the conversion unit 201 and converts the Ethernet data into the 64-bit data. In addition, the monitor 211 continuously monitors a line usage rate of the Ethernet data that has been converted into the 64-bit data. In addition, the monitor 212 outputs line usage rate information indicating the monitored line usage rate to the multiplexer 240.

The line usage rate in the Ethernet data, which has been monitored by each of the monitors 211 and 212 is, for example, a rate of the actual data transfer speed of the Ethernet data to the maximum data transfer speed of the Ethernet data. For example, each of the monitors 211 and 212 calculates a line usage rate in accordance with a percentage of pieces of valid data and idle signals (IDLE signals) included in pieces of Ethernet data in a specific time period.

The buffer 221 stores the input Ethernet data. The buffer 222 stores the Ethernet data that has been output from the conversion unit 201.

The ODU flex framer 231 reads the Ethernet data stored in the buffer 221 and converts valid data (for example, a MAC frame) in the read Ethernet data into an ODU flex frame. The ODU flex frame is, for example, a frame in which the payload capacity is allowed to be set flexibly depending on a bit rate of the stored client signal. The ODU flex framer 231 outputs the converted ODU flex frame to the multiplexer 240. As a result, the Ethernet data from which an idle signal has been removed and the band of which has been compressed is converted into an ODU flex frame and output to the multiplexer 240.

Similarly, the ODU flex framer 232 reads the Ethernet data stored in the buffer 222. In addition, the ODU flex framer 232 converts valid data in the read Ethernet data into an ODU flex frame. In addition, the ODU flex framer 232 outputs the converted ODU flex frame to the multiplexer 240.

The multiplexer 240 allocates the ODU flex frames that have been output from the ODU flex framers 231 and 232 to TSs (for example, TSs #1 to #100). For example, the multiplexer 240 allocates the ODU flex frames that have been output from the ODU flex framer 231 (signals of the tributary port #1) to the TS#1 to #20. The multiplexer 240 allocates the ODU flex frames that have been output from the ODU flex framer 232 (signals of the tributary port #2) to the TS#21 to #100.

In addition, the multiplexer 240 outputs each of the ODU flex frames to an ODTUCn framer corresponding to the TS to which the ODU flex frame has been allocated from among the ODTUCn framers 251 and 252. For example, the multiplexer 240 outputs the ODU flex frames that have been allocated to the TSs #1 to #20 to the ODTUCn framer 251. The multiplexer 240 outputs the ODU flex frames that have been allocated to the TSs #21 to #100 to the ODTUCn framer 252.

The multiplexer 240 detects occurrence of a failure in one or more of physical lines used to transmit the OTUCn frames, in accordance with input line failure information. For example, the line failure information is input to the multiplexer 240 from an optical module that is at a later stage than the OTUCn framer 290. When the multiplexer 240 detects the failure that has occurred in one or more of the physical lines, the multiplexer 240 selects one or more physical lines used as relief lines from among the physical lines in each of which a failure has not detected, in accordance with the pieces of line usage rate information respectively output from the monitors 211 and 212.

When a single relief line has been selected, the multiplexer 240 allocates (maps) the ODU flex frames that have been allocated to the TSs corresponding to the line in which the failure has been detected (failure line), to TSs corresponding to the relief line. When two or more relief lines has been selected, the multiplexer 240 determines a rate of allocation of a valid data amount of the ODU flex frames that have been allocated to the TSs corresponding to the failure line to the two or more relief lines. In addition, the multiplexer 240 allocates, to the TSs corresponding to the two or more relief lines, the ODU flex frames that have been allocated to the TSs corresponding to the failure line, in accordance with the determined rate.

The multiplexer 240 adds destination port information to the OH of the ODU flex frame that has been allocated to the TS corresponding to the failure line. The OH is an abbreviation of overhead. The destination port information added to the OH of the ODU flex frame is information indicating a TP (port) of the ODU flex frame.

For example, when the ODU flex frame that has been allocated to the TS corresponding to the failure line is an ODU flex frame from the ODU flex framer 231 (data of the tributary port #1), the multiplexer 240 adds destination port information indicating the tributary port #1 to the OH of the ODU flex frame. When the ODU flex frame that has been allocated to the TS corresponding to the failure line is an ODU flex frame from the ODU flex framer 232 (data of the tributary port #2), the multiplexer 240 adds destination port information indicating the tributary port #2 to the OH of the ODU flex frame.

Alternatively, the destination port information added to the OH of the ODU flex frame may be information indirectly indicating a TP (port) of the ODU flex frame. For example, the destination port information added to the OH of the ODU flex frame may be information indicating a TS corresponding to the failure lines, to which the ODU flex frame has been originally allocated. In this case, the reception side may identify a TP (port) of the ODU flex frame with reference to an MSI that is correspondence information between TSs and TPs and the destination port information.

Alternatively, the destination port information added to the OH of the ODU flex frame may be correspondence information in which a TP of the ODU flex frame and a TS to which the ODU flex frame has been allocated (TS for a relief line) are associated with each other.

As a result, the ODU flex frame that has been allocated to the TS corresponding to the failure line is allocated to the TS corresponding to a relief line in which the failure does not occur and is output to the ODTUCn framers 251 and 252 in a state in which destination port information has been added to the OH of the ODU flex frame.

As an example, it is assumed that the two or more physical lines includes the first to fifth physical lines, and the TSs #1 to #20 are transmitted through the first physical line, and the TSs #21 to #100 are transmitted through the second to the fifth physical lines. In addition, it is assumed that a failure occurs only in the fifth physical line from among the first to the fifth physical lines, and the multiplexer 240 selects the first to the fourth physical lines as relief lines. It is assumed that the line usage rate that has been monitored by the monitor 211 is 30%, and the line usage rate that has been monitored by the monitor 212 is 40%.

In this case, the line usage rate of the first physical line through which pieces of data of the tributary port #1 are transmitted is estimated to be 30% that has been monitored by the monitor 211. Each line usage rate of the second to the fourth physical lines through each of which pieces of data of the tributary port #2 are transmitted is estimated to be 40% that has been monitored by the monitor 212. Therefore, the line usage rate of the first to fourth physical lines may be estimated as 30:40:40:40.

Thus, for example, the multiplexer 240 allocates the ODU flex frames that have been allocated to the fifth physical line (for example, TSs #81 to #100) before occurrence of the failure, to the first to fourth physical lines with the ratio of “1/3:1/4:1/4:1/4=4:3:3:3”. Alternatively, the multiplexer 240 may allocate the ODU flex frames that have been allocated to the fifth physical line before occurrence of the failure, to the first to fourth physical lines with the ratio of “100-30:100-40:100-40:100−40=7:6:6:6”.

However, an allocation method based on line usage rates by the multiplexer 240 is not limited to such an example, and various allocation methods may be applied. For example, the multiplexer 240 may select relief lines in accordance with line usage rates and allocate ODU flex frames corresponding to the failure line to the selected relief lines evenly.

The ODTUCn framer 251 converts the ODU flex frames that have been allocated to the first physical line by the multiplexer 240, for example, into an ODTUCn frame corresponding to the TSs #1 to #20, in accordance with the allocation result by the multiplexer 240. In addition, the ODTUCn framer 251 outputs the converted ODTUCn frame to the ODTUGCn framer 260. The ODTUCn framer 252 converts the ODU flex frames that have been output from the multiplexer 240, for example, into an ODTUCn frame corresponding to the TSs #21 to #100 in accordance with the allocation result by the multiplexer 240. In addition, the ODTUCn framer 252 outputs the converted ODTUCn frame to the ODTUGCn framer 260.

The ODTUGCn framer 260 converts the ODTUCn frames that have been output from the ODTUCn framers 251 and 252 into an ODTUGCn frame by time-division multiplexing. In addition, the ODTUGCn framer 260 outputs the converted ODTUGCn frame to the OPUCn framer 270.

The OPUCn framer 270 converts the ODTUGCn frame that has been output from the ODTUGCn framer 260 into an OPUCn frame. In addition, the OPUCn framer 270 outputs the converted OPUCn frame to the ODUCn framer 280. The ODUCn framer 280 converts the OPUCn frame that has been output from the OPUCn framer 270 into an ODUCn frame. In addition, the ODUCn framer 280 outputs the converted ODUCn frame to the OTUCn framer 290.

The OTUCn framer 290 converts the ODUCn frame that has been output from the ODUCn framer 280 into an OTUCn frame. In addition, the OTUCn framer 290 outputs the converted OTUCn frame to the second transmission device 120. For example, the OTUCn frame that has been output from the OTUCn framer 290 is transmitted to the second transmission device 120 as two or more OTUCn sub-frames through respective two or more physical lines.

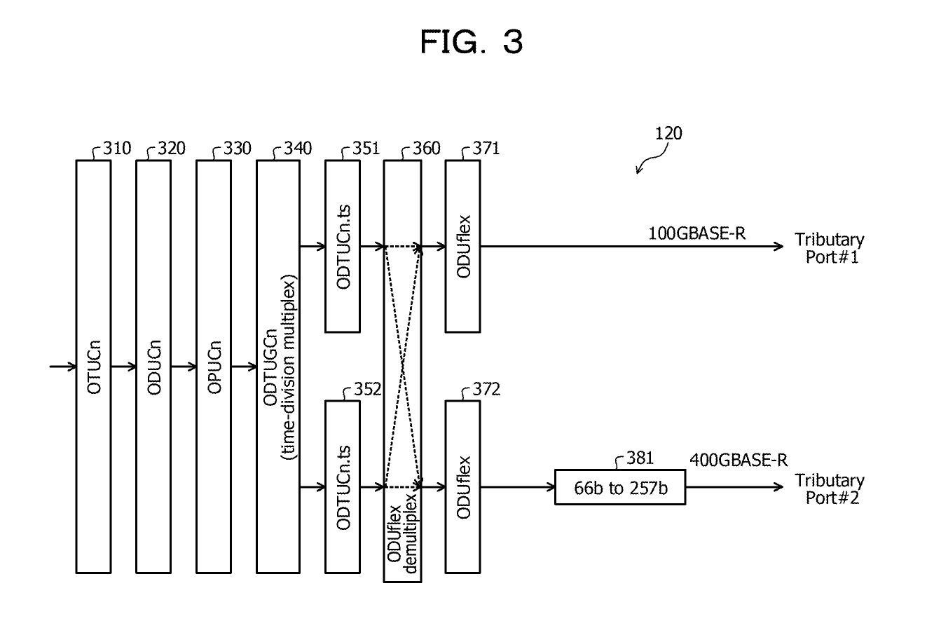

FIG. 3 is a diagram illustrating an example of the second transmission device according to the embodiment. The second transmission device 120 on the reception side illustrated in FIG. 1 may be realized, for example, by a second transmission device 120 illustrated in FIG. 3. The second transmission device 120 illustrated in FIG. 3 includes, for example, an OTUCn deframer 310 (OTUCn), an ODUCn deframer 320 (ODUCn), and an OPUCn deframer 330 (OPUCn). The second transmission device 120 includes an ODTUGCn deframer 340 (ODTUGCn) and ODTUCn deframers 351 and 352 (ODTUCn.ts). The second transmission device 120 includes a demultiplexer 360 (ODU flex de-multiplex), ODU flex deframers 371 and 372 (ODU flex), and a conversion unit 381 (66b to 257b).

The reception unit 121 illustrated in FIG. 1 may be realized, for example, by the OTUCn deframer 310. The extraction unit 122 illustrated in FIG. 1 may be realized by a configuration obtained by removing the OTUCn deframer 310 and the tributary ports #1 and #2 from the configuration illustrated in FIG. 3.

In the example illustrated in FIG. 3, the second transmission device 120 includes the two ports (tributary ports #1 and #2). In addition, the second transmission device 120 outputs the Ethernet data that has been input to the tributary port #1 of the first transmission device 110 illustrated in FIG. 2, through the tributary port #1 of the second transmission device 120. The second transmission device 120 outputs the Ethernet data that has been input to the tributary port #2 of the first transmission device 110 illustrated in FIG. 2, through the tributary port #2 of the second transmission device 120.

First, the OTUCn frame that has been transmitted as the two or more OTUCn sub-frames through the respective physical lines is input to the OTUCn deframer 310 from the first transmission device 110. The OTUCn deframer 310 converts the input OTUCn frame into an ODUCn frame. In addition, the OTUCn deframer 310 outputs the converted ODUCn frame to the ODUCn deframer 320.

The ODUCn deframer 320 converts the ODUCn frame that has been output from the OTUCn deframer 310 into an OPUCn frame. In addition, the ODUCn deframer 320 outputs the converted OPUCn frame to the OPUCn deframer 330. The OPUCn deframer 330 converts the OPUCn frame that has been output from the ODUCn deframer 320 into an ODTUGCn frame. In addition, the OPUCn deframer 330 outputs the converted ODTUGCn frame to the ODTUGCn deframer 340.

The ODTUGCn deframer 340 converts the ODTUGCn frame that has been output from the OPUCn deframer 330 into ODTUCn frames by time-division demultiplexing. In addition, the ODTUGCn deframer 340 outputs an ODTUCn frame corresponding to the TSs #1 to #20 from among the converted ODTUCn frames to the ODTUCn deframer 351. The ODTUGCn deframer 340 outputs an ODTUCn frame corresponding to the TSs #21 to #100 from among the converted ODTUCn frames to the ODTUCn deframer 352.

The ODTUCn deframer 351 converts the ODTUCn frame corresponding to the TSs #1 to #20, which has been output from the ODTUGCn deframer 340, into ODU flex frames. In addition, the ODTUCn deframer 351 outputs the converted ODU flex frames to the demultiplexer 360.

The ODTUCn deframer 352 converts the ODTUCn frame corresponding to the TSs #21 to #100, which have been output from the ODTUGCn deframer 340, into ODU flex frames. In addition, the ODTUCn deframer 352 outputs the converted ODU flex frames to the demultiplexer 360.

The demultiplexer 360 determines a TP (for example, the tributary port #1 or #2) corresponding to each of the ODU flex frames that have been output from the ODTUCn deframer 351 and 352, in accordance with the MSI included in the ODU flex frame. For example, the demultiplexer 360 determines that a TP is the tributary port #1 for an ODU flex frame in which destination port information is not added to the OH, which corresponds to the TSs #1 to #20. The demultiplexer 360 determines that a TP is the tributary port #2 for an ODU flex frame in which destination port information is not added to the OH, which corresponds to the TSs #21 to #100.

The demultiplexer 360 determines a TP of an ODU flex frame in which destination port information has been added to the OH, in accordance with the destination port information that has been added to the OH of the ODU flex frame.

In addition, the demultiplexer 360 outputs each of the ODU flex frames to an ODU flex deframer corresponding to the determined TP from among the ODU flex deframers 371 and 372. For example, the demultiplexer 360 outputs the ODU flex frame in which the TP has been determined to be the tributary port #1, to the ODU flex deframer 371. The demultiplexer 360 outputs the ODU flex frame in which the TP that has been determined to be the tributary port #2, to the ODU flex deframer 372.

The ODU flex deframer 371 converts (demaps) the ODU flex frame that has been output from the demultiplexer 360 into Ethernet data (for example, a MAC frame). In addition, the ODU flex deframer 371 outputs the converted Ethernet data through the tributary port #1 as Ethernet data of the 100GBASE-R specification such that a 96-bit IDLE signal is inserted between packets at the minimum.

Similarly, the ODU flex deframer 372 converts the ODU flex frame that has been output from the demultiplexer 360 into Ethernet data. In addition, the ODU flex deframer 372 outputs the converted Ethernet data to the conversion unit 381 such that a 96-bit IDLE signal is inserted between packets at the minimum.

The conversion unit 381 converts the Ethernet data (66 bits) that has been output from the ODU flex deframer 372 into 257-bit Ethernet data. In addition, the conversion unit 381 outputs the converted Ethernet data through the tributary port #2 as Ethernet data of the 400GBASE-R specification.

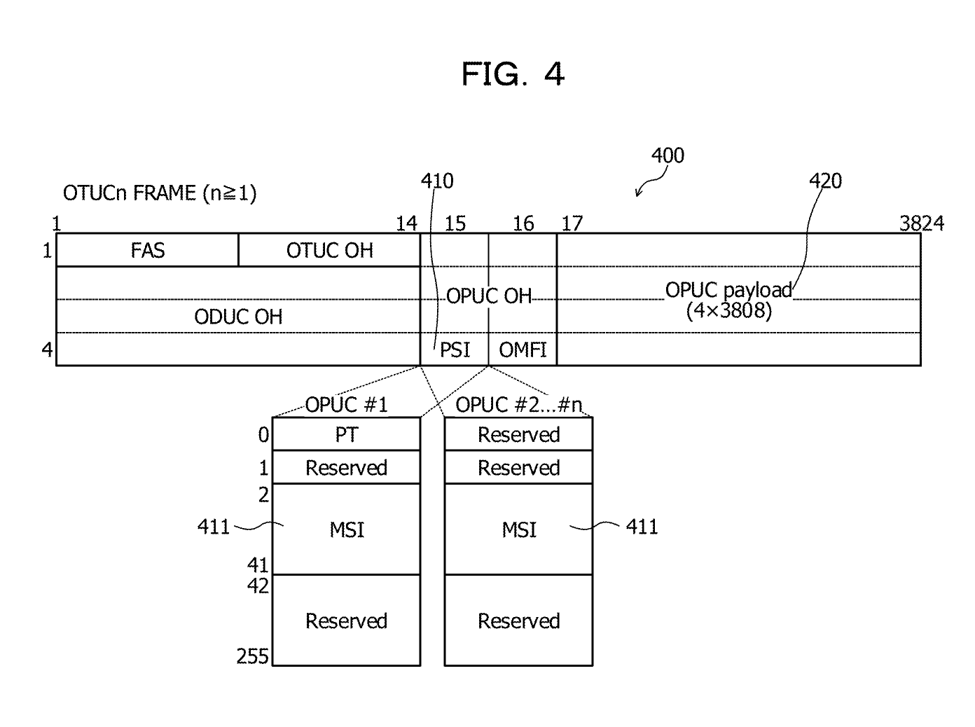

FIG. 4 is a diagram illustrating an example of an OTUCn frame transmitted in the transmission system according to the embodiment. For example, the first transmission device 110 transmits an OTUCn frame 400 illustrated in FIG. 4 to the second transmission device 120. Here, an MSI 411 is included in a PSI 410 of an OPUC OH of the OTUCn frame 400. The OPUC is an abbreviation of optical-channel payload unit. The PSI is an abbreviation of payload structure identifier.

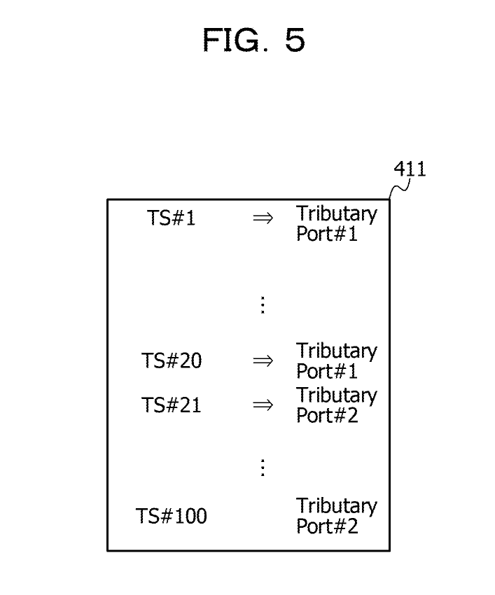

The MSI 411 is an OH (correspondence information) in which TSs and TPs are associated with each other (for example, see FIG. 5). For example, the MSI 411 is transmitted at 256-frame cycles and is obtained by combining PSIs 410 of 256 OTUCn frames 400.

In a payload 420 of the OTUCn frame 400 (OPUC payload), for example, the above-described Ethernet data is stored. For example, two or more TSs are included in the payload 420, and the Ethernet data is allocated to each of the TSs of the payload 420 as an ODU flex frame.

FIG. 5 is a diagram illustrating an example of an MSI included in an OTUCn frame transmitted in the transmission system according to the embodiment. For example, as illustrated in FIG. 5, in the MSI 411 illustrated in FIG. 4, TSs (TSs #1 to #100) and TPs (the tributary port #1 and the tributary port #2) are associated with each other. That is, the MSI 411 is information indicating, for each of the TSs #1 to #100 of the payload of the OTUCn frame 400, a port corresponding to a frame (for example, an ODU flex frame) stored in the TS.

In the example illustrated in FIG. 5, the TSs #1 to #20 are associated with the tributary port #1, and the TSs #21 to #100 are associated with the tributary port #2. The demultiplexer 360 of the second transmission device 120 determines an output port for an ODU flex frame to which destination port information is not added, in accordance with a TS in which the ODU flex frame is stored and the MSI 411.

For example, the demultiplexer 360 outputs the ODU flex frame (no destination port information) corresponding to the TSs #1 to #20, which has been output from the ODTUCn deframer 351, to the ODU flex deframer 371 corresponding to the tributary port #1. The demultiplexer 360 outputs the ODU flex frame (no destination port information) corresponding to the TSs #21 to #100, which has been output from the ODTUCn deframer 352, to the ODU flex deframer 372 corresponding to the tributary port #2.

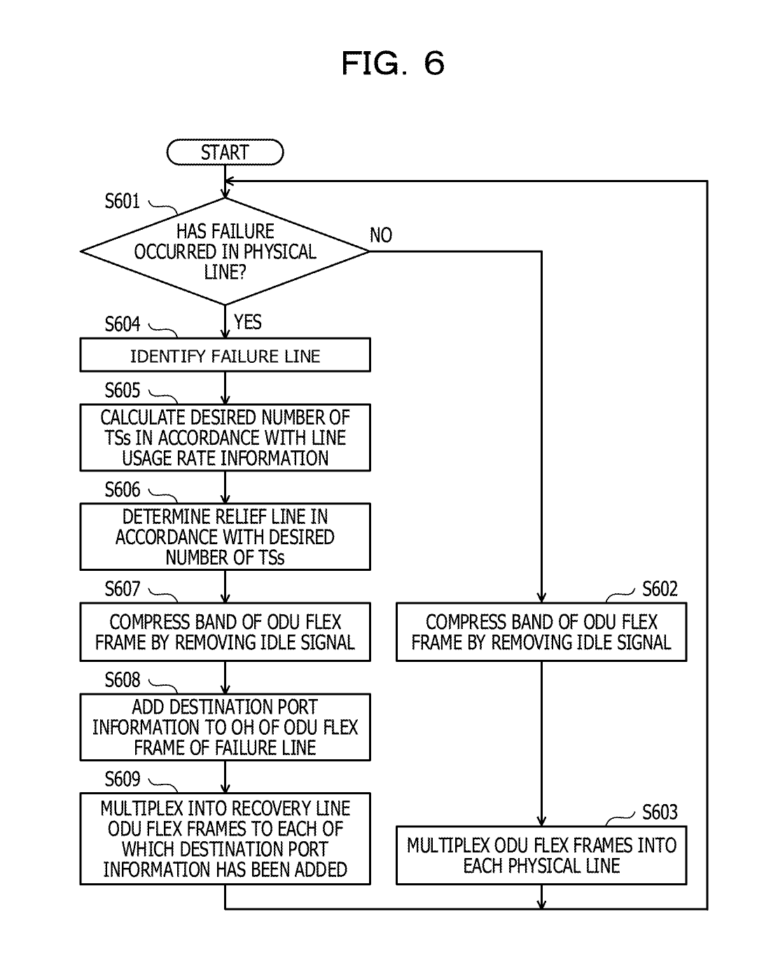

FIG. 6 is a flowchart illustrating an example of processing by the first transmission device according to the embodiment. For example, the first transmission device 110 on the transmission side according to the embodiment executes steps illustrated in FIG. 6. First, the first transmission device 110 determines whether a failure has occurred in any one of physical lines (for example, the first to fifth physical lines) between the first transmission device and the second transmission device 120 (S601). The processing in S601 is executed, for example, by the multiplexer 240. For example, the multiplexer 240 determines whether a failure has occurred in any one of the physical lines, in accordance with line failure information output from an optical module.

In S601, when the multiplexer 240 determines that a failure has not occurred (S601: No), the first transmission device 110 compresses the band of an ODU flex frame by removing an idle signal (S602). The processing in S602 is executed by removing the idle signal, for example, when the ODU flex framers 231 and 232 respectively read the pieces of Ethernet data from the buffers 221 and 222.

Next, the first transmission device 110 multiplexes the ODU flex frames into each of the physical lines (S603), and the flow returns to S601. The processing in S603 is executed, for example, when the multiplexer 240 allocates the ODU flex frames to the TSs #1 to #100. For example, the multiplexer 240 allocates the ODU flex frames from the ODU flex framer 231 to the TSs #1 to #20. The multiplexer 240 allocates the ODU flex frames from the ODU flex framer 232 to the TSs #21 to #100.

In S601, when the multiplexer 240 determines that a failure has occurred (S601: Yes), the first transmission device 110 identifies one or more failure lines in each of which the failure has occurred from among the physical lines (S604). The processing in S604 is executed, for example, when the multiplexer 240 refers to the line failure information.

Next, the first transmission device 110 calculates the number of TSs desired for diversion away from the failure lines, in accordance with pieces of line usage rate information (S605). The processing in S605 is executed, for example, by the multiplexer 240. For example, for each of the failure lines that have been identified in S604, the multiplexer 240 calculates “the number of TSs=(transmission capacity per physical line)×(line usage rate of the failure line)/(transmission capacity per TS)”. In addition, the multiplexer 240 calculates the number of TSs desired for diversion away from the failure lines by combining the number of TSs of the failure lines.

The transmission capacity per physical line is, for example, 100 [Gbps]. The transmission capacity per TS is, for example, 5 [Gbps]. When the failure line is the first physical line, the line usage rate that has been monitored by the monitor 211 may be used, for example, as the line usage rate of the failure line. When the failure line is the second to fourth physical lines, the line usage rate that has been monitored by the monitor 212 may be used, for example, as the line usage rate of the failure line.

Next, the first transmission device 110 determines which relief lines are to be used for relief of the failure lines from among the physical lines other than the failure lines that have been identified in S604, in accordance with the desired number of TSs that has been calculated in S605 (S606). The processing in S606 is executed, for example, by the multiplexer 240.

For example, the multiplexer 240 sets physical lines different from the failure lines from among the physical lines as relief line candidates, and calculates, for each of the relief line candidates, “the number of empty TSs=(transmission capacity per physical line)×(line vacancy rate of the relief line candidate)/(transmission capacity per TS)”. In addition, the multiplexer 240 cumulatively combines the number of empty TSs that has been calculated for the relief line candidates until the cumulative value reaches the number of desired TSs. In addition, the multiplexer 240 determines, as relief lines, relief line candidates corresponding to the number of empty TSs that have been combined until the cumulative value reaches the desired number of TSs.

When the relief line candidate is the first physical line, a line vacancy rate of the relief line candidate may be obtained, for example, by subtracting the line usage rate [%] that has been monitored by the monitor 211 from 100[%]. When the relief line candidate is the second to fourth physical lines, the line vacancy rate of the relief line candidate may be obtained, for example, by subtracting the line usage rate [%] that has been monitored by the monitor 212 from 100[%].

Next, the first transmission device 110 compresses the band of the ODU flex frame by removing an idle signal (S607). The band compression in S607 is similar to the band compression in S602.

Next, the first transmission device 110 adds destination port information to the OH of the ODU flex frame of the failure line (S608). The processing in S608 is executed, for example, by the multiplexer 240. For example, when the ODU flex frame of the failure line is an ODU flex frame from the ODU flex framer 231 (data of the tributary port #1), the first transmission device 110 adds destination port information indicating the tributary port #1 to the OH of the ODU flex frame. When the ODU flex frame of the failure line is an ODU flex frame from the ODU flex framer 232 (data of the tributary port #2), the first transmission device 110 adds destination port information indicating the tributary port #2 to the OH of the ODU flex frame.

Next, the first transmission device 110 multiplexes, into the relief lines, the ODU flex frames of the failure lines, to each of which destination port information has been added by the processing in S608 (S609), and the flow returns to S601. The processing in S609 is executed, for example, when the multiplexer 240 allocates, to TSs corresponding to the relief line, the ODU flex frames that have been allocated to the TSs corresponding to the failure line. The multiplexer 240 does not change allocation of the ODU flex frames that have been allocated to the TSs corresponding to the physical lines in each of which a failure has not occurred.

In the example illustrated in FIG. 6, the processing is described in which the desired number of TSs is calculated in accordance with pieces of line usage rate information, relief lines are determined in accordance with the calculated desired number of TSs, and the ODU flex frames are diverted away from the failure lines by using the determined relief lines. However, the embodiment is not limited to such processing.

For example, processing may be applied in which physical lines other than failure lines are determined to be relief lines, and a multiplexing ratio for the relief lines is determined in accordance with pieces of line usage rate information. Alternatively, processing may be applied in which one or more of the physical lines other than the failure lines, which have been determined in accordance with pieces of line usage rate information, are determined to be relief lines.

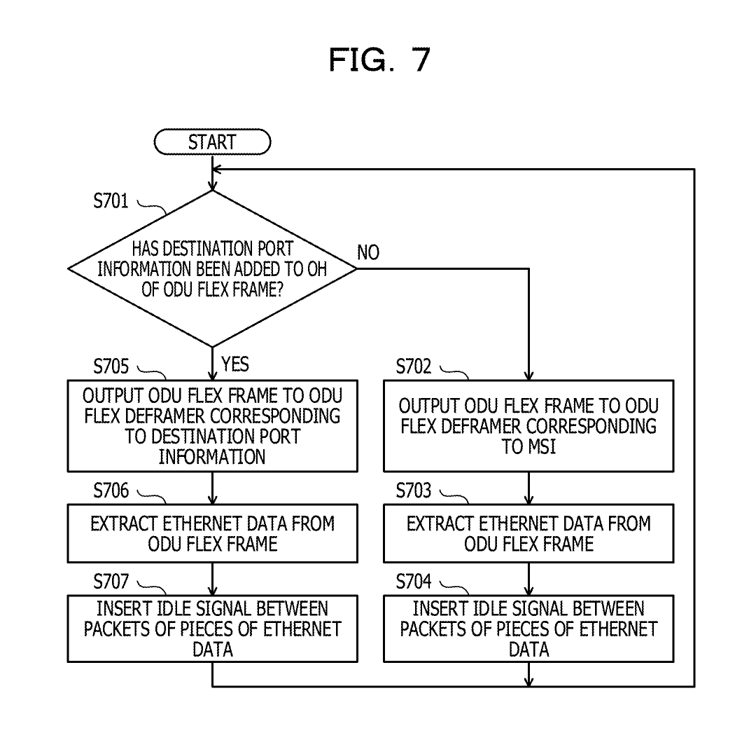

FIG. 7 is a flowchart illustrating an example of processing by the second transmission device according to the embodiment. For example, the second transmission device 120 on the reception side according to the embodiment executes steps illustrated in FIG. 7. First, the second transmission device 120 determines whether destination port information is added to the OH of the ODU flex frame that has been received from the first transmission device 110 (S701). The processing in S701 is executed, for example, when the demultiplexer 360 refers to the OH of the received ODU flex frame.

In S701, when the second transmission device 120 determines that destination port information is not added to the OH of the ODU flex frame (S701: No), in the second transmission device 120, the flow proceeds to S702. That is, the second transmission device 120 outputs the received ODU flex frame to an ODU flex deframer corresponding to the MSI (S702). The processing in S702 is executed, for example, by the demultiplexer 360.

For example, the demultiplexer 360 outputs the ODU flex frames corresponding to the TSs #1 to #20, which have been output from the ODTUCn deframer 351, to the ODU flex deframer 371 in accordance with the MSIs. The demultiplexer 360 outputs the ODU flex frames corresponding to the TSs #21 to #100, which have been output from the ODTUCn deframer 352, to the ODU flex deframer 372 in accordance with the MSIs.

Next, the second transmission device 120 extracts Ethernet data from the received ODU flex frame (S703). The processing in S702 is executed, for example, by an ODU flex deframer that is an output destination of the ODU flex frame in S702 from among the ODU flex deframers 371 and 372.

Next, the second transmission device 120 inserts a 96-bit idle signal between packets of the pieces of Ethernet data that have been extracted in S703 (S704), and the flow returns to S701. The processing in S704 is executed, for example, by the ODU flex deframer that is the output destination of the ODU flex frame in S702 from among the ODU flex deframers 371 and 372.

In S701, when the second transmission device 120 determines that destination port information has been added to the OH of the ODU flex frame (S701: Yes), in the second transmission device 120, the flow proceeds to S705. That is, the second transmission device 120 outputs the received ODU flex frame to a port of the ODU flex deframer corresponding to the destination port information (S705). The processing in S705 is executed, for example, by the demultiplexer 360.

For example, when the destination port information indicates the tributary port #1, the demultiplexer 360 outputs the received ODU flex frame to the ODU flex deframer 371. When the destination port information indicates the tributary port #2, the demultiplexer 360 outputs the received ODU flex frame to the ODU flex deframer 372.

Next, the second transmission device 120 extracts Ethernet data from the received ODU flex frame (S706). For example, the extraction of Ethernet data in S706 is similar to the extraction of Ethernet data in S703. Next, the second transmission device 120 inserts a 96-bit idle signal between packets of the pieces of Ethernet data that have been extracted in S706 (S707), and the flow returns to S701. For example, the insertion of an idle signal in S707 is similar to the insertion of an idle signal in S704.

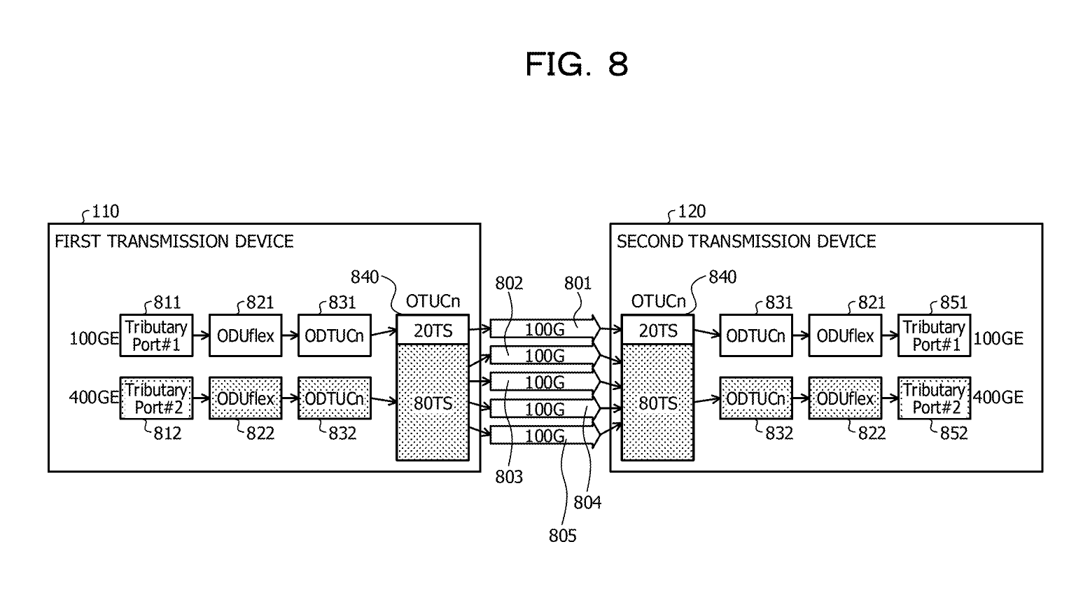

FIG. 8 is a diagram illustrating an example of transmission of an OTUCn frame in the transmission system according to the embodiment. In FIG. 8, physical lines 801 to 805 (100G) each has a 100 [Gbps] band and correspond to, for example, the above-described the lines 101 to 10n (n=4) or the first to fifth physical lines. In the example illustrated in FIG. 8, it is assumed that a failure does not occur in any one of the physical lines 801 to 805.

In this case, the band of 100GE Ethernet data that has been input from an input port 811 (tributary port #1) of the first transmission device 110 is compressed due to removal of an idle signal, and the 100GE Ethernet data is converted into an ODU flex frame 821 (ODU flex). The ODU flex frames 821 are converted into an ODTUCn frame 831 (ODTUCn). The ODTUCn frame 831 is allocated to TSs #1 to #20 (20TS) of an OTUCn frame 840 (OTUCn) and transmitted through the physical line 801.

The band of 400GE Ethernet data that has been input from an input port 812 (tributary port #2) is compressed due to removal of an idle signal, and the 400GE Ethernet data is converted into an ODU flex frame 822 (ODU flex). The ODU flex frames 822 are converted into an ODTUCn frame 832 (ODTUCn). The ODTUCn frame 832 is allocated to TSs #21 to #100 (80TS) of the OTUCn frame 840 (OTUCn) and transmitted to physical lines 802 to 805.

The second transmission device 120 receives the OTUCn frame 840 through the physical lines 801 to 805. The ODTUCn frame 831 is extracted from the TSs #1 to #20 (20TS) of the OTUCn frame 840, and the ODU flex frames 821 are extracted from the ODTUCn frame 831. The 100GE Ethernet data that has been extracted from the ODU flex frame 821 is output through an output port 851 (tributary port #1).

The ODTUCn frame 832 is extracted from the TSs #21 to #100 (80TS) of the OTUCn frame 840, and the ODU flex frames 822 are extracted from the ODTUCn frame 832. The 400GE Ethernet data that has been extracted from the ODU flex frame 822 is output through an output port 852 (tributary port #2).

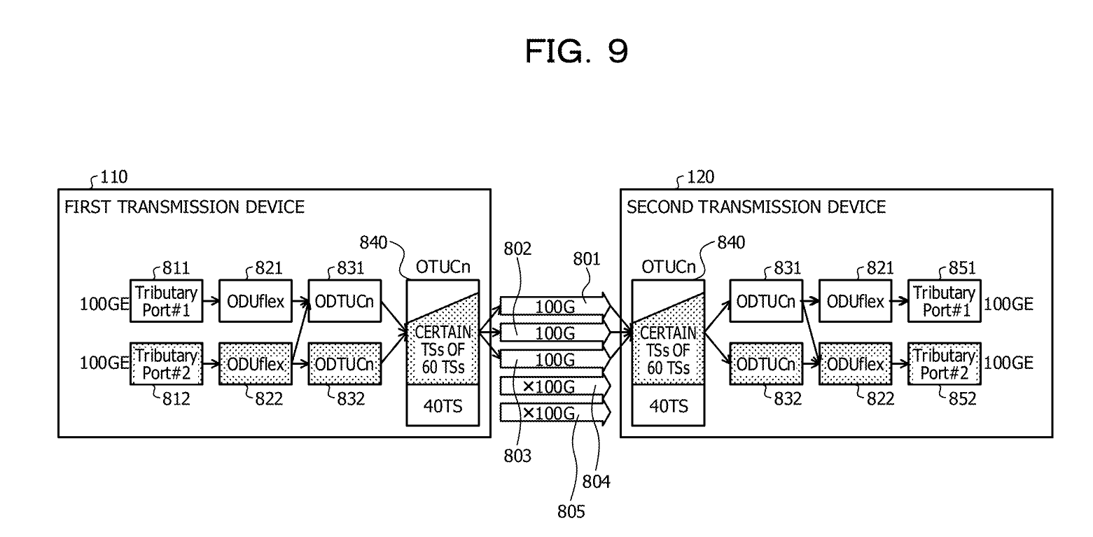

FIG. 9 is a diagram illustrating an example of failure of some physical lines and diversion away from the physical line of in the transmission system according to the embodiment. In FIG. 9, the same symbol is applied to a part similar to the part illustrated in FIG. 8, and the description is omitted herein. In the example illustrated in FIG. 9, a failure has occurred in the physical lines 804 and 805 from among the physical lines 801 to 805.

In this case, it is difficult to transmit the TSs #61 to #100 (40TS) of the OTUCn frame 840 through the physical lines 804 and 805. In addition, it is possible to transmit the TSs #1 to #60 (60TS) of the OTUCn frame 840 through the physical lines 801 to 803.

The first transmission device 110 converts the ODU flex frames that have been allocated to the TSs #61 to #100, into the ODTUCn frame 831 by allocating, to the TSs #1 to #60, the ODU flex frames that have been allocated to the TSs #61 to #100 by the multiplexer 240. The first transmission device 110 adds destination port information indicating the output port 852 (tributary port #2) corresponding to the input port 812 to the OHs of the ODU flex frames that have been allocated to the TSs #1 to #60 from among the ODU flex frames 822.

As a result, the ODU flex frames 821 and 822 are transmitted through the physical lines 801 to 803 by using the TSs #1 to #60 (60TS) of the OTUCn frame 840. At this time, the ODU flex frames 822 may be allocated to certain TSs from among the TSs #1 to #60 (60TS) of the OTUCn frame 840.

The second transmission device 120 sets the ODU flex frames that have been extracted from the ODTUCn frame 831, in each of which the destination port information indicating the output port 852 (tributary port #2) has been added to the OH, as the ODU flex frames 822. As a result, for example, the ODU flex frames 822 that have been allocated to the TSs #1 to 20 and have transmitted through the physical line 801 may also be output through the output port 852.

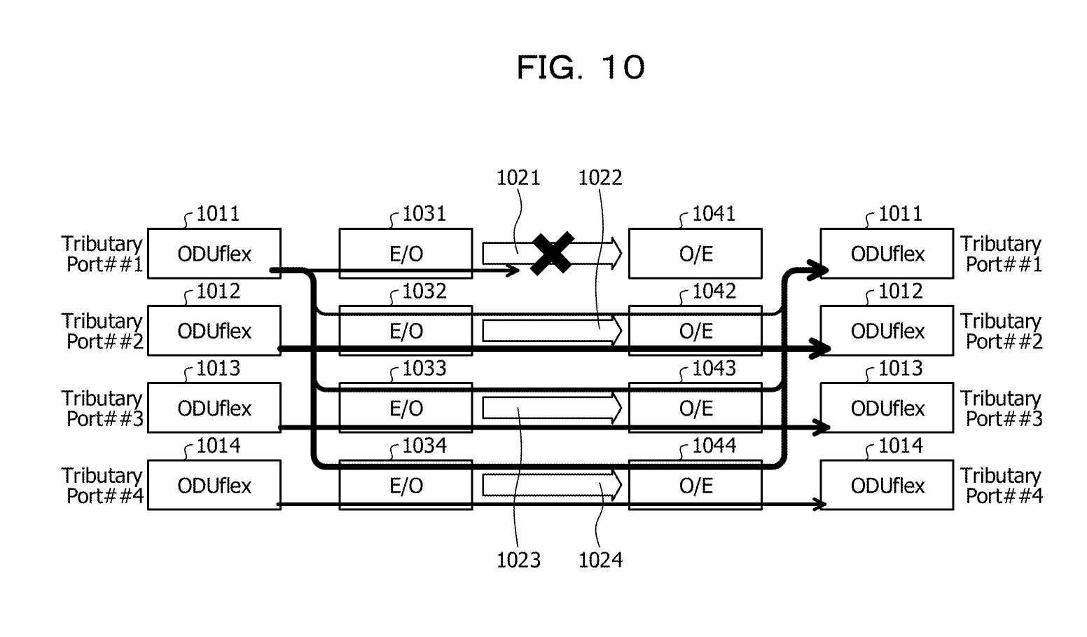

FIG. 10 is a diagram illustrating an example of allocation of pieces of data to relief lines in the transmission system according to the embodiment. In the example illustrated in FIG. 10, in each of the first transmission device 110 and the second transmission device 120, four ports #1 to #4 are provided as TPs. ODU flex frames 1011 to 1014 are ODU flex frames that store pieces of data that have been input through the Ports #1 to #4 of the first transmission device 110, respectively.

In the example illustrated in FIG. 10, the first transmission device 110 and the second transmission device 120 are coupled to each other through physical lines 1021 to 1024. In addition, when a failure does not occur in any one of the physical lines 1021 to 1024, the ODU flex frames 1011 to 1014 are respectively transmitted through the physical lines 1021 to 1024.

Electro-optic conversion units 1031 to 1034 (E/O) are transmission ends of the first transmission device 110, which respectively generate optical signals to be transmitted through the physical lines 1021 to 1024. Each of the electro-optic conversion units 1031 to 1034 (E/O) may be realized, for example, by a laser diode (LD) or the like. The electro-optic conversion units 1031 to 1034 respectively output the generated optical signals to the physical lines 1021 to 1024.

Optic-electro conversion units 1041 to 1044 (O/E) are reception ends of the second transmission device 120, which respectively convert the optical signals that have been transmitted through the physical lines 1021 to 1024 into electric signals. Each of the optic-electro conversion units 1041 to 1044 may be realized, for example, by a photo detector (PD).

For example, a failure has occurred in the physical line 1021 from among the physical lines 1021 to 1024. In this case, the first transmission device 110 divides and transmits the ODU flex frames 1011 that have been transmitted through the physical line 1021, through the physical lines 1022 to 1024. The first transmission device 110 dynamically determines an allocation rate of the ODU flex frames 1011 to the physical lines 1022 to 1024 depending on a result that has been obtained by estimating line usage rates of the physical lines 1022 to 1024 in accordance with line usage rates of the Ports #1 to #4.

In FIG. 10, the thickness of an arrow indicating each flow of the ODU flex frames 1011 to 1014 represents the height of the corresponding line usage rate. That is, the line usage rates of the physical lines 1022 to 1024 through which the ODU flex frames 1012 to 1014 are respectively transmitted are high in this order.

In this case, the first transmission device 110 sets an allocation rate of the ODU flex frames 1011 high in order of the physical lines 1024, 1023, and 1022. As a result, the more ODU flex frames 1011 are allocated to a physical line having a high line vacancy rate from among the physical lines 1022 to 1024, and the ODU flex frames 1011 to 1014 may be transmitted through the physical lines 1022 to 1024 efficiently.

The first transmission device 110 adds (performs labelling of) destination port information indicating the Port #1 to the OH of the ODU flex frame 1011. The second transmission device 120 obtains the ODU flex frame to which the destination port information indicating the Port #1 has been added from among the ODU flex frames that have been transmitted through the physical lines 1022 to 1024 as the ODU flex frame 1011 corresponding to the Port #1.

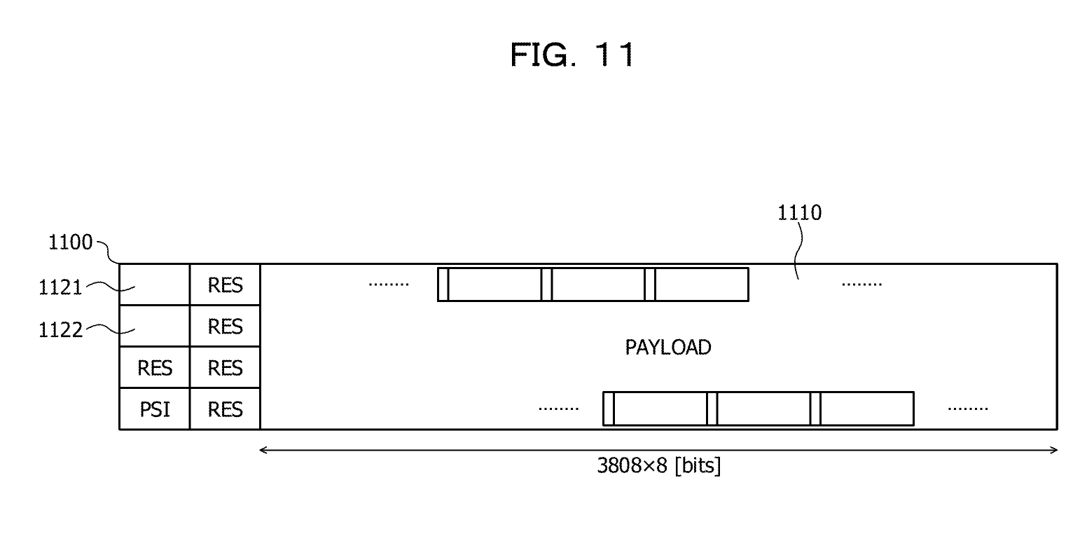

FIG. 11 is a diagram illustrating an example of an ODU flex frame according to the embodiment. For example, the first transmission device 110 stores valid data that has been extracted by removing an idle signal from Ethernet data in a payload 1110 of an ODU flex frame 1100 illustrated in FIG. 11. In addition, when a failure has occurred in one or more of physical lines, switching of a line is performed in a unit of the ODU flex frame 1100.

The first transmission device 110 adds destination port information indicating a port of the ODU flex frame 1100, for example, to OHs 1121 and 1122 of an ODU flex frame that has been allocated to a TS corresponding to the failure line 1100.

The second transmission device 120 extracts the valid data of the Ethernet data from the payload 1110 of the received ODU flex frame 1100. When destination port information is included in each of the OHs 1121 and 1122 of the received ODU flex frame 1100, the second transmission device 120 outputs the ODU flex frame 1100 through an output indicated by the destination port information.

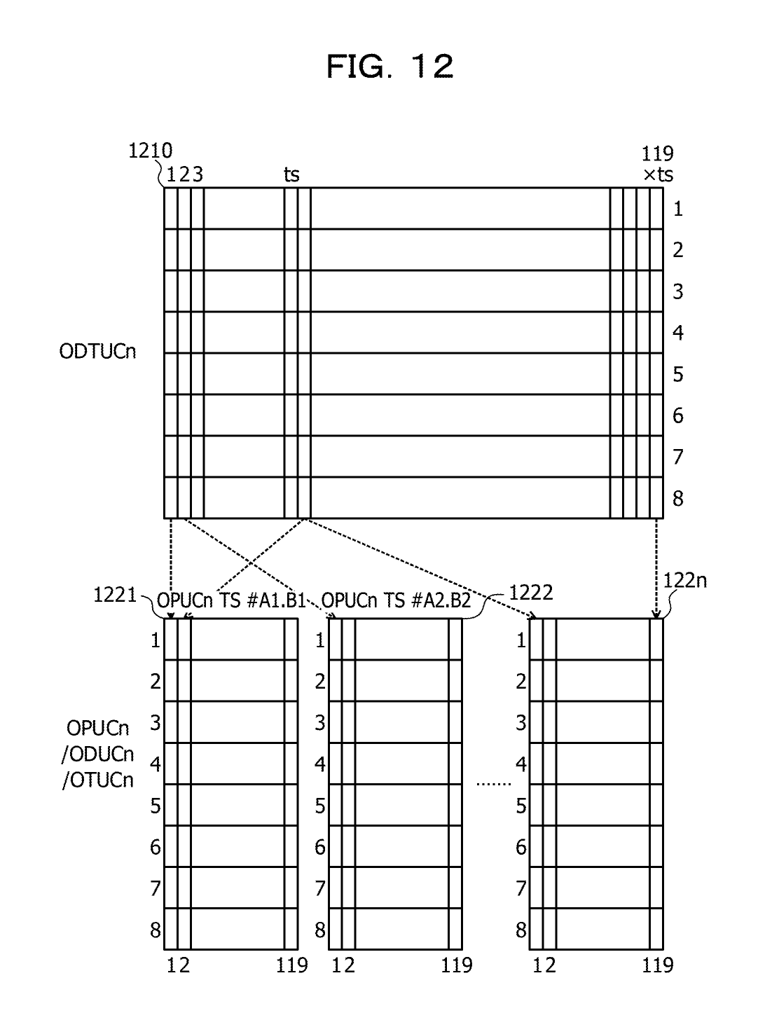

FIG. 12 is a diagram illustrating an example of an ODTUCn frame and OPUCn/ODUCn/OTUCn frames according to the embodiment. The first transmission device 110 maps the ODU flex frame 1100 illustrated in FIG. 11, for example, to each TS (ts) of an ODTUCn frame 1210 illustrated in FIG. 12. The first transmission device 110 converts the ODTUCn frame 1210 to which the ODU flex frames 1100 have mapped into OPUCn/ODUCn/OTUCn frames 1221, 1222, . . . , and 122n (sub-frames).

In addition, the first transmission device 110 respectively transmits the converted OPUCn/ODUCn/OTUCn frames 1221, 1222, . . . , and 122n through two or more physical lines. For example, the first transmission device 110 respectively transmits the OPUCn/ODUCn/OTUCn frames 1221, 1222, . . . , and 122n from the electro-optic conversion units 1031 to 1034 illustrated in FIG. 10 (in a case of “n=4”).

The second transmission device 120 respectively receives the OPUCn/ODUCn/OTUCn frames 1221, 1222, . . . , and 122n through the two or more physical lines. The second transmission device 120 extracts the ODTUCn frame 1210 from the received OPUCn/ODUCn/OTUCn frames 1221, 1222, . . . , and 122n. In addition, the second transmission device 120 extracts the ODU flex frames 1100 illustrated in FIG. 11 from the extracted the ODTUCn frame 1210.

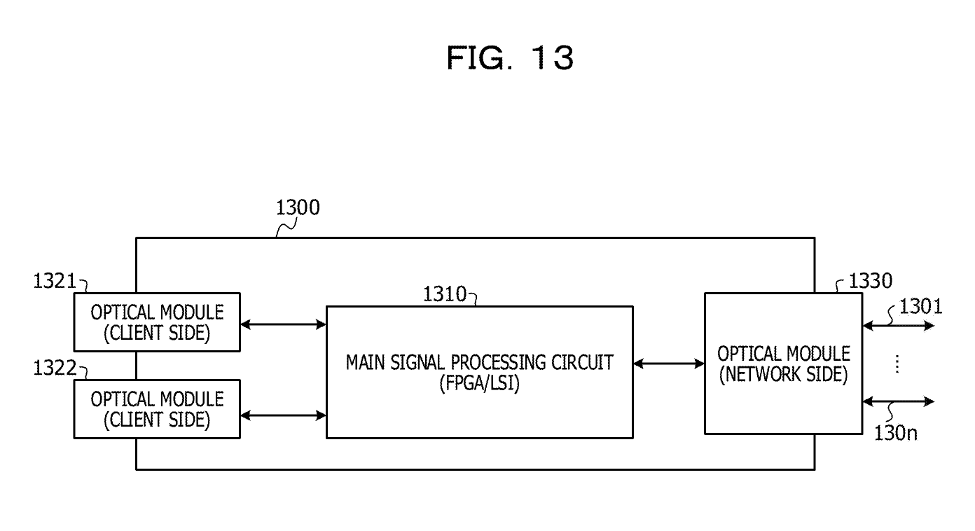

FIG. 13 is a diagram illustrating an example of a hardware configuration of each of the transmission devices according to the embodiment. Each of the first transmission device 110 and the second transmission device 120 may be realized, for example, by a transmission device 1300 illustrated in FIG. 13.

The transmission device 1300 includes, for example, a main signal processing circuit 1310 and optical modules 1321, 1322, and 1330. In addition, the transmission device 1300 may include a device CPU that controls the main signal processing circuit 1310 and the optical modules 1321, 1322, and 1330, and a memory that the device CPU is allowed to access. The CPU is an abbreviation of central processing unit.

The memory may include, for example, a main memory and an auxiliary memory. The main memory is, for example, a random access memory (RAM). The main memory is used as a work area of the device CPU. The auxiliary memory is, for example, a non-volatile memory such as a magnetic disk, an optical disk, or a flash memory. In the auxiliary memory, various programs that operate the transmission device 1300 are stored. The programs stored in the auxiliary memory are loaded into the main memory and executed by the device CPU.

When the transmission device 1300 is applied to the first transmission device 110 illustrated in FIG. 2, each of the configurations of the first transmission device 110 illustrated in FIG. 2 may be realized, for example, by the main signal processing circuit 1310. When the transmission device 1300 is applied to the second transmission device 120 illustrated in FIG. 3, each of the configurations of the second transmission device 120 illustrated in FIG. 3 may be realized, for example, by the main signal processing circuit 1310.

The main signal processing circuit 1310 is coupled to each of the optical modules 1321, 1322, and 1330 through a high-speed signal line. In addition, the main signal processing circuit 1310 processes main signals transmitted and received to and from the optical modules 1321, 1322, and 1330. The main signal processing circuit 1310 may be realized, for example, by a digital circuit such as a field programmable gate array (FPGA) or a large scale integration (LSI).

For example, the main signal processing circuit 1310 processes signals (electric signals) that have been output from the optical module 1321 and 1322, and outputs the processed signals to the optical module 1330. The main signal processing circuit 1310 processes signals (electric signals) that have been output from the optical module 1330 and outputs the processed signals to the optical modules 1321 and 1322.

Each of the optical modules 1321 and 1322 on the client side is coupled to the client side, and transmits and receives optical signals under the control of the main signal processing circuit 1310. For example, each of the optical modules 1321 and 1322 converts an optical signal that has been received from the client side into an electric signal and outputs the converted electric signal to the main signal processing circuit 1310. Each of the optical modules 1321 and 1322 converts a signal (electric signal) that has been output from the main signal processing circuit 1310 into an optical signal and transmits the converted optical signal to the client side.

For example, when the transmission device 1300 is applied to the first transmission device 110, signals input from the above-described two or more input ports are signals input from the optical modules 1321 and 1322 to the main signal processing circuit 1310. When the transmission device 1300 is applied to the second transmission device 120, signals output from the above-described two or more output ports are signals output from the main signal processing circuit 1310 to the optical modules 1321 and 1322.

The optical module 1330 on the network side is coupled to the network side through two or more physical lines 1301 to 130n, and transmits and receives optical signals under the control of the main signal processing circuit 1310. For example, when the transmission device 1300 is applied to the first transmission device 110, the network side corresponds to, for example, the second transmission device 120. In this case, the electro-optic conversion units 1031 to 1034 illustrated in FIG. 10 are included, for example, in the optical module 1330. When the transmission device 1300 is applied to the second transmission device 120, the network side corresponds to, for example, the first transmission device 110. In this case, the optic-electro conversion units 1041 to 1044 illustrated in FIG. 10 are included, for example, in the optical module 1330.

For example, the optical module 1330 converts an optical signal that has been received from the network side into an electric signal and outputs the converted electric signal to the main signal processing circuit 1310. The optical module 1330 converts a signal (electric signal) that has been output from the main signal processing circuit 1310 into an optical signal and transmits the converted optical signal to the network side.

The configuration is described above in which the two optical modules 1321 and 1322 are provided on the client side. However, the number of optical modules on the client side is not limited to two and any number of optical modules may be provided. The configuration is described above in which the single optical module 1330 is provided on the network side. However, the number of optical modules on the network side is not limited to one and any number of optical modules may be provided.

The configuration is described above in which the optical modules 1321 and 1322 are provided as communication modules on the client side. However, the communication module on the client side is not limited to the optical module, and an electric communication module may be used.

As described above, in the embodiment, in the configuration in which an OTUCn frame that stores two or more ODU flex frames is divided and transmitted through two or more physical lines, data other than an idle signal may be extracted from an input signal, and the extracted data may be stored in an ODU flex frame. As a result, an ODU flex frame the band of which has been compressed may be obtained. In addition, when a failure has occurred in one or more of the physical lines, an ODU flex frame corresponding to the physical line in which the failure has occurred may be stores in a TS of the OTUCn frame, which is to be transmitted through another physical line. As a result, even when a failure has occurred in one or more of the physical lines, impact on the communication service may be suppressed.

For example, in the related art, association of TPs and TSs of an OTUCn frame is fixed, and occupation of TSs is fixed regardless of a valid data amount of Ethernet data, such that a line usage efficiency is reduced by an idle signal portion. As an example, when piece of data of 100GE and 400GE are transmitted, the 100GE line occupies 20 TSs for the OTUCn frame, and the 400GE line occupies 80 TSs for the OTUCn frame.

In contrast, the first transmission device 110 executes the processing in a unit of an ODU flex frame, thereby being independent of TSs, such that a line band may be used flexibly. Only a single piece of Ethernet data is allowed to be stored in a single TS, but two or more pieces of Ethernet data are allowed to be multiplexed into a single TS due to the processing in a unit of an ODU flex frame, and the line usage efficiency is improved. As a result, even when diversion away from a failure line is performed, a transmission delay time of Ethernet signal may be suppressed.

As described above, in the transmission device and the transmission method according to the embodiment, impact on the communication service may be suppressed even when a failure occurs in one or more of lines.

For example, in ITU-T G. 709 Recommendation, an OTUCn has been defined that is a frame used to transport data of Beyond 100G (B100G). The ITU-T is an abbreviation of International Telecommunication Union-Telecommunication sector. In the OTUCn, bonding (channel bonding) of two or more optical signals (optical modules of 100G) is performed to logically treat the signals of 100 [Gbps] or more as a single line.

The OTUCn is a standard in which two or more optical signals are logically treated as a single line. Therefore, when a failure (partial failure) has been physically occurred in one or more of optical modules, transmission of all optical signals is stopped, or transmission of a failure notification signal is performed. Thus, the partial failure causes the total disconnection of the high capacity line, thereby affecting the service. Therefore, it is desirable that impact on the service due to partial failure is suppressed.

For example, a method is conceived in which association of TSs and TPs is changed such that a TS corresponding to a line in which a failure has occurred is not used, and a MSI is updated when the failure has occurred in the line. However, in such a method, for example, intervention of an operator is desired for update of an MSI, and therefore, there is a problem in which it takes a long time to update the MSI. As described above, a transmission cycle of the MSI is long, a 256-frame cycle, and therefore, there is a problem in which it takes a long time until diversion away from the failure line is performed after the MSI has been updated.

In contrast, the above-described embodiment uses, for example, a fact that the line usage rate of valid data does not reach 100% and a time period of an idle signal between packets exists, for Ethernet data mapped to the OTUCn, in a packet scheme of Ethernet. That is, the above-described first transmission device 110 compresses the band of Ethernet data not by performing mapping of an idle signal of Ethernet data. As a result, diversion away from a failure line may be performed while impact on a relief line is suppressed, and impact on the communication service such as total disconnection of the whole line may be suppressed.

The first transmission device 110 allocates data to a relief line in accordance with a percentage of an idle signal in Ethernet data transmitted through a line in which a failure does not occur (line usage rate). As a result, diversion away from a failure line is performed efficiently in accordance with line usage rates of lines allowed to be used for the relief, and impact on the communication service may be suppressed.

The first transmission device 110 may perform diversion away from a line instantly without intervention of the operator or the like by labelling destination port information to the OH of the ODU flex frame in the multiplexer 240. For example, the frame cycle of the ODU flex frame is about 1.182 [μs] in the case of 100 GbE and is about 0.295 [μs] in the case of 400 GbE, and diversion away from the line is performed in the shortest period of time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a processor configured to:
extract data other than an idle signal from an input signal,
generate a first frame in which the extracted data is stored, and
store generated first frames in a second frame, each of the generated first frames being the first frame; and
a transmitter coupled to the processor and configured to:
divide the second frame to transmit through a plurality of lines corresponding to storage areas of the first frames in the second frame among the plurality of lines, and
when a failure occurs in a line among the plurality of lines, store the first frame corresponding to the line in which the failure occurs in an area, the first frame in the area being to be transmitted through a line different from the line in which the failure occurs.

2. The transmission device according to claim 1,
wherein the first frame is a frame obtained by first framing operation among framing operations performed before the extracted data is stored in the second frame.

3. The transmission device according to claim 1, wherein the processor is configured to:
generate the first frame for each of input signals from a plurality of ports, and
store the generated first frame in the second frame such that the first frame is transmitted through a line corresponding to an input port of data of the first frame,
wherein the second frame includes correspondence information between the areas of the second frame, in each of which the first frame is stored, and the plurality of ports.

4. The transmission device according to claim 3, wherein the processor is configured to:
when the failure occurs, add information indicating the port of the data of the first frame corresponding to the line in which the failure occurs from among the plurality of ports, to the first frame, and
store the first frame to which the information is added in the area, the first frame in the are being to be transmitted by the different line.

5. The transmission device according to claim 3, wherein the processor is configured to
when the failure occurs, store the first frame corresponding to the line in which the failure occurs in the area, the first frame of the area being to be transmitted by the different line, in accordance with information indicating a line usage rate of each of the input signals from the plurality of ports.

6. A transmission method executed by a transmission device, the transmission method comprising:
extracting, by a processor, data other than an idle signal from an input signal;
generating a first frame in which the extracted data is stored;
storing generated first frames in a second frame, each of the generated first frames being the first frame;
dividing, by a transmitter, the second frame to transmit through a plurality of lines corresponding to storage areas of the first frames in the second frame among the plurality of lines; and
when a failure occurs in a line among the plurality of lines, storing the first frame corresponding to the line in which the failure occurs in an area, the first frame in the area being to be transmitted by a line different from the line in which the failure occurs.

7. The transmission method according to claim 6,
wherein the first frame is a frame obtained by first framing operation among framing operations performed before the extracted data is stored in the second frame.

8. The transmission method according to claim 6, wherein
the generating the first frame includes generating the first frame for each of input signals from a plurality of ports, and
the storing the generated first frames includes storing the generated first frame in the second frame such that the first frame is transmitted through a line corresponding to an input port of data of the first frame,
wherein the second frame includes correspondence information between the areas of the second frame, in each of which the first frame is stored, and the plurality of ports.

9. The transmission method according to claim 8, further comprises
when the failure occurs, adding information indicating the port of the data of the first frame corresponding to the line in which the failure occurs from among the plurality of ports, to the first frame, and
wherein the storing the first frame includes
storing the first frame to which the information is added in the area, the first frame in the are being to be transmitted by the different line.

10. The transmission method according to claim 8, wherein the storing the first frame includes
when the failure occurs, storing the first frame corresponding to the line in which the failure occurs in the area, the first frame of the area being to be transmitted by the different line, in accordance with information indicating a line usage rate of each of the input signals from the plurality of ports.

11. A transmission device comprising:
a first processor configured to:
extract data other than an idle signal from an input signal,
generate a first frame in which the extracted data is stored,
store generated first frames in a second frame, each of the generated first frames being the first frame, and
divide the second frame to transmit through a plurality of lines corresponding to storage areas of the first frames in the second frame among the plurality of lines; and
a receiver coupled to the first processor and configured to
receive the second frame divided and transmitted through the lines from another transmission device in which the first frame corresponding to a line in which a failure occurs from among the plurality of lines is stored in an area, the second frame in the area being to be transmitted through a line different from the line in which the failure occurs; and
a second processor coupled to the receiver and configured to
extract the data from the second frame received at the receiver.
